(19) United States
(12) Patent Application Publication
(10) Pub. No.: US 2008/0011898 A1
(43) Pub. Date: Jan. 17, 2008

(54) Flying saucer

(76) Inventor: Richard Wilton White, El Cajon, CA (US)

Correspondence Address: Richard W. White, #5 660 Van Houton, El Cajon, CA, 92020-3144, US

(21) Appl. No.: 11/484,553

(22) Filed: Jul. 12, 2006

(51) Int. Cl. B64C 29/00

(52) U.S. Cl. 244/12.3

(57) ABSTRACT

Multiple engines (with individual propellers), mounted upon a platform, with swivel mounts ganged together to a single control stick, to direct their propelled energy downward, giving said platform precise control. Said platform supported via three spring landing struts.

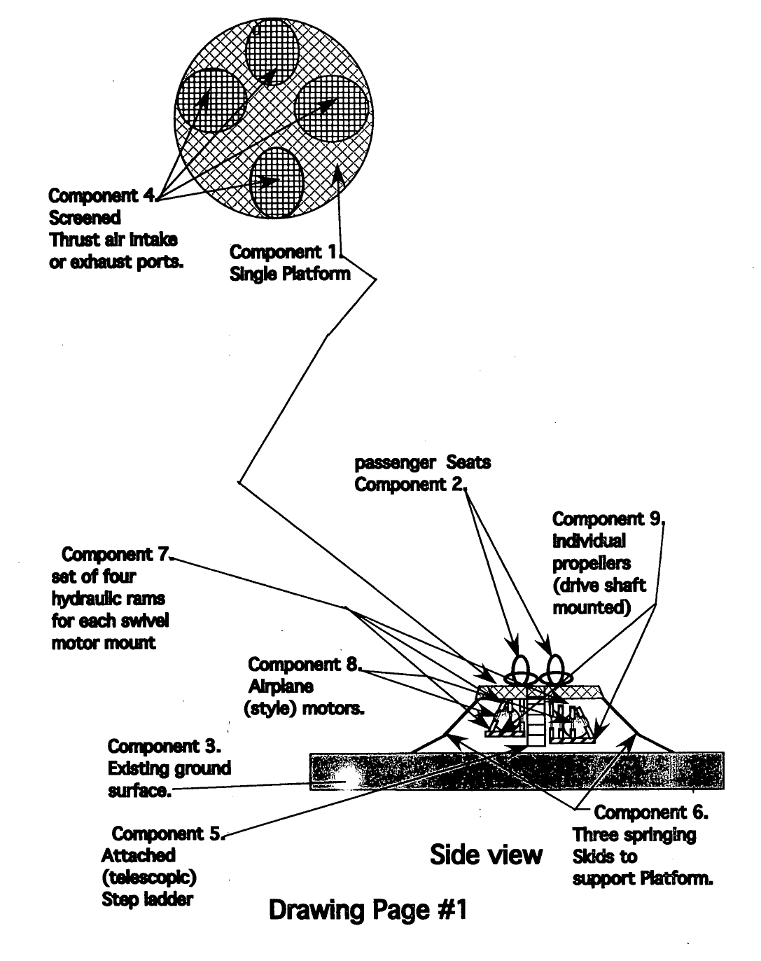

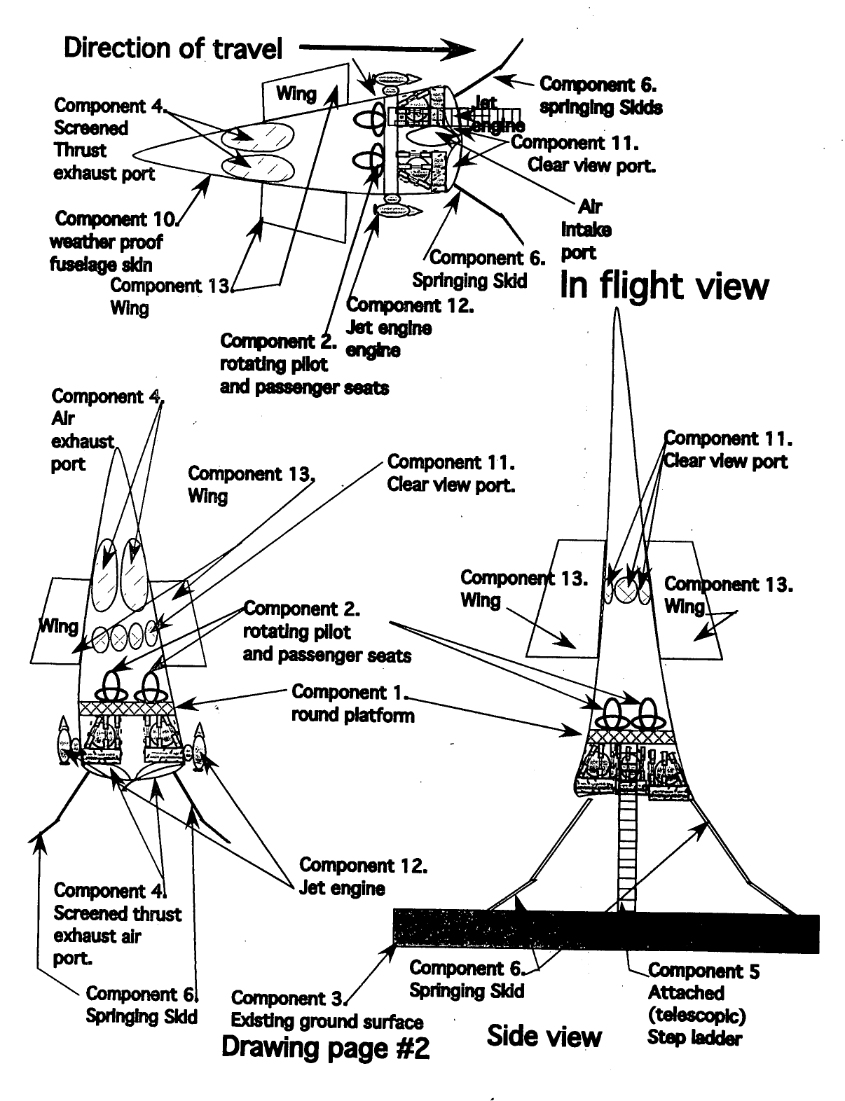

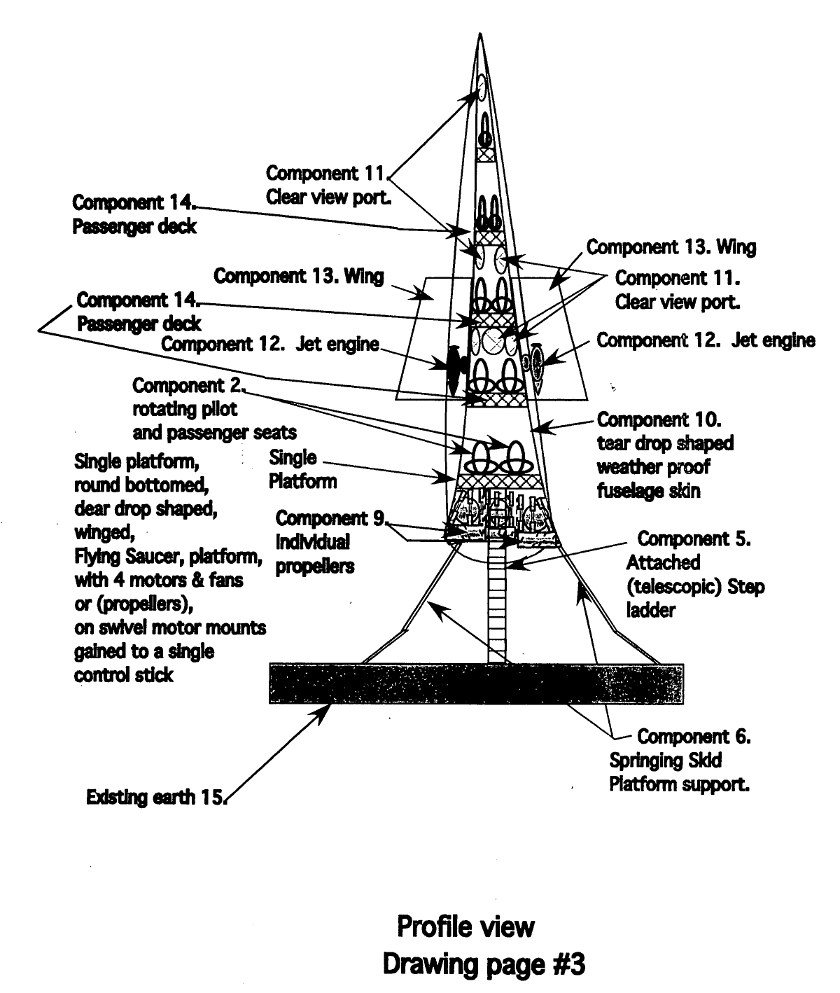

### BACKGROUND OF THE INVENTION

There has been no similar device, patented or marketed anywhere in the world.

The idea of employing multiple engines, mounted a single platform, with all the engines motor mounts ganged together to a single control, to direct their propelled energy downward, is totally new!

The attached drawings numbers 1 and 2, illustrates the concept.

Description of the drawings together with a description of the individual components and their function:

Component 1. A round platform affixed with multiple airplane (styled) motors Component 8, all of which Component 8 motors are mounted upon swivel motor mounts 7, each said motor powering drive shaft mounted to Component 9 individual propellers, with said motors all ganged to a single control stick, to enable the pilot to direct all the motors in the direction of their propeller thrust.

Component 3. Existing ground surface

Component 4. Screened air intake or exhaust ports for airflow

Component 5. Attached (telescopic) Stepladder

Component 6. Springing Skid to support Platform.

Component 7. 4 hydraulic rams for each swivel motor mount

Component 8. Airplane (style) motors.

Component 9. individual propellers

Component 10. teardrop shaped weather proof fuselage skin

Component 11. Clear view port.

Component 12. Jet engine

Component 13. Wing

Component 14. Passenger deck

What I claim:

1. A powered vehicle, able to transport people or goods through the air, moving vertical on take off, and landing in any place large enough to accommodate said vehicle.

2. In alternate versions of this invention, the aerodynamically shaped fuselage would be shaped as a teardrop, with wings affixed and powered by Jet engines affixed to the frame under laying the fuselage, together with multiple passenger decks.
